(19) United States
(12) Patent Application Publication
(10) Pub. No.: US 2010/0298044 A1
(43) Pub. Date: Nov. 25, 2010

(54) SYSTEM AND METHOD FOR BEHAVIORAL GAMING

(75) Inventor: John F. Acres, Corvallis, OR (US)

Correspondence Address: MARGER JOHNSON & MCCOLLOM, P.C., 210 SW MORRISON STREET, SUITE 400, PORTLAND, OR, 97204, US

(73) Assignee: ACRES-FIORE PATENTS, Las Vegas, NV (US)

(21) Appl. No.: 12/469,002

(22) Filed: May 20, 2009

(51) Int. Cl. A63F 9/24; A63F 13/00

(52) U.S. Cl. 463/25; 463/30

(57) ABSTRACT

Embodiments of the present invention are directed to systems and methods for behavioral gaming. A method of conducting a game of chance comprises: establishing behavioral gaming criteria at a gaming server, collecting statistical data associated with a player from a plurality of gaming sessions; comparing the statistical data to the behavioral gaming criteria; and initiating an action responsive to the comparing to alter behavior of the player. The behavioral gaming limits can be provided by a casino or by the player. The responsive actions can include messages displayed on a gaming device, changes to the functionality of the gaming device, and intervention by casino personnel or third parties.

### FIELD OF THE INVENTION

This disclosure relates generally to gaming devices, and more particularly to behavioral play on gaming devices.

### BACKGROUND

Gaming is a popular activity for persons of all ages. Popular games include both automated games, in which a player plays against a machine, such as slots, poker, bingo, etc., as well as those games in which a player plays against live individuals such as a dealer or other players. Gaming is enjoyed both by players who view the experience as entertainment, as well as those who pursue gaming for financial gain.

Although most individuals can appropriately manage their gaming activities so as not to out-spend their resources, some people have trouble with such management. For example, some may establish a limit on their spending before beginning play, but during play, they may lose their ability to stop at the pre-set limit due to various psychological factors. This inability to stop playing when appropriate can have detrimental effects on the individual, their families, and their friends. Further, this type of behavior is undesirable for the casino, whose goal is to provide a pleasurable entertainment experience for players to maximize profits.

Traditional approaches to resolving this problem have focused on the individual, such as counseling and abstinence programs. Such approaches heavily rely on the individual's ability to learn and apply self-management techniques. Consequently, the success of such approaches is intimately tied to the individual's psychology, and thus, may or may not be successful.

Therefore, a need remains for a method to minimize the likelihood that individual players will over-spend on gambling that is not dependent on the psychological fortitude of the individual.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, and 2C are detail diagrams of exemplary types of gaming devices according to embodiments of the invention.

FIG. 3 is a functional block diagram of networked gaming devices according to embodiments of the invention.

FIG. 4 is a functional block diagram that illustrates a gaming device according to some embodiments of the invention.

FIG. 5 illustrates a method of operating a gaming device according to some embodiments of the invention.

FIG. 6 illustrates another method of operating a gaming device according to some embodiments of the invention.

### DETAILED DESCRIPTION

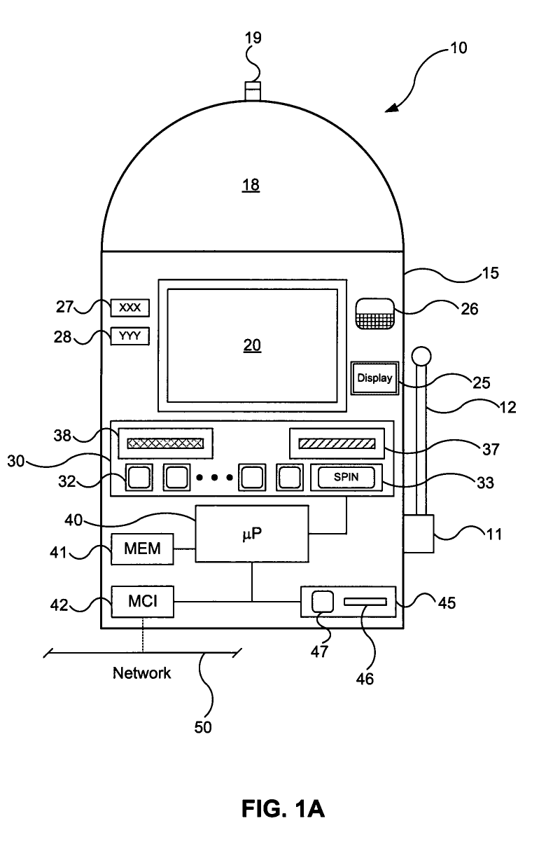

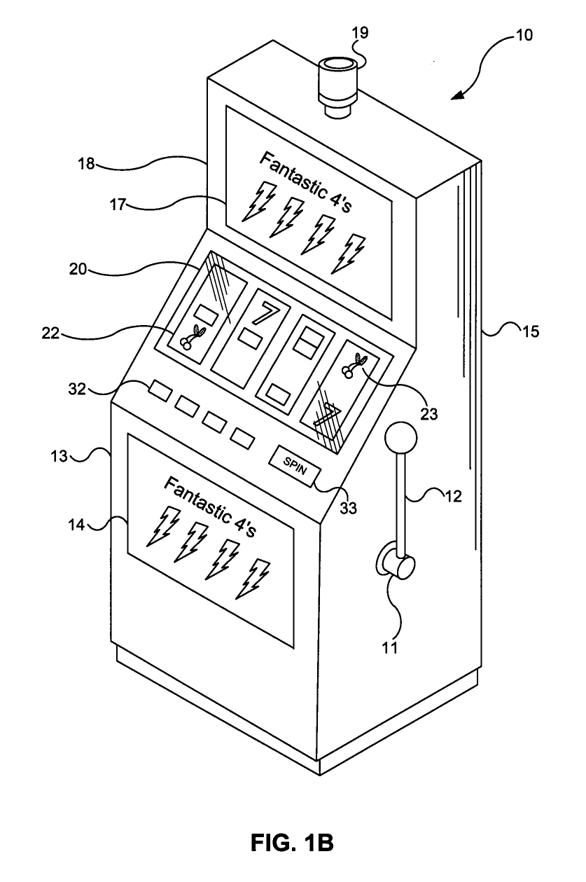

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electromechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, and other similar devices. Although embodiments of the invention will work with all of the gaming types mentioned, for ease of illustration the present embodiments will be described in reference to the electronic gaming machine 10 shown in FIGS. 1A and 1B.

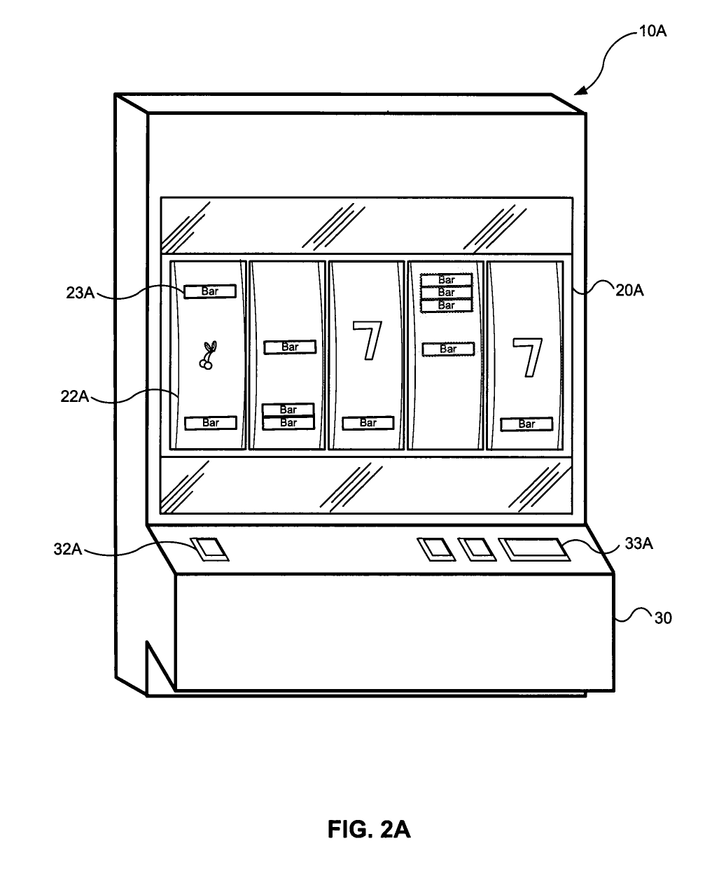

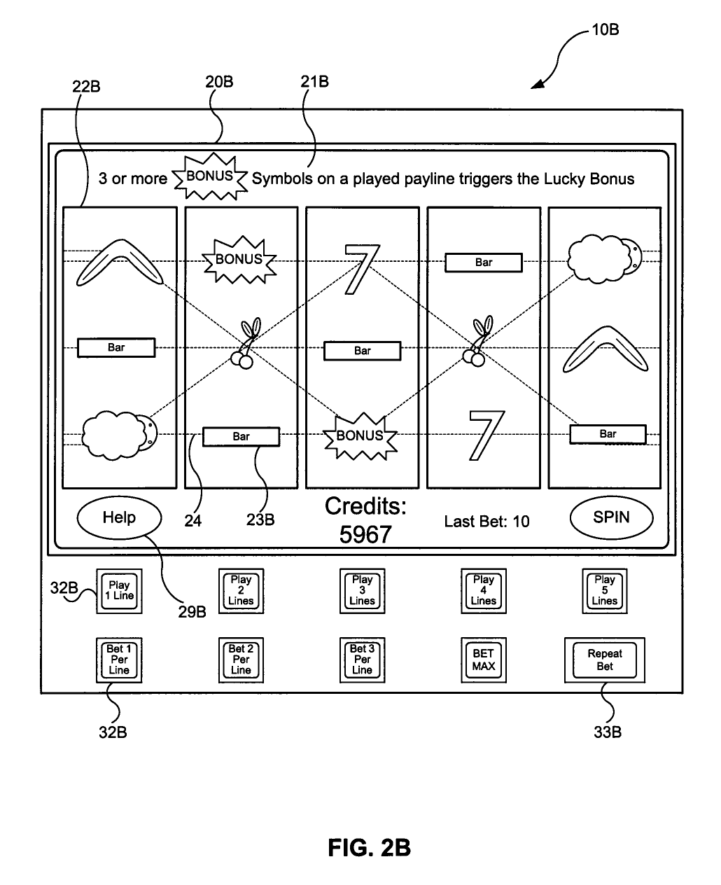

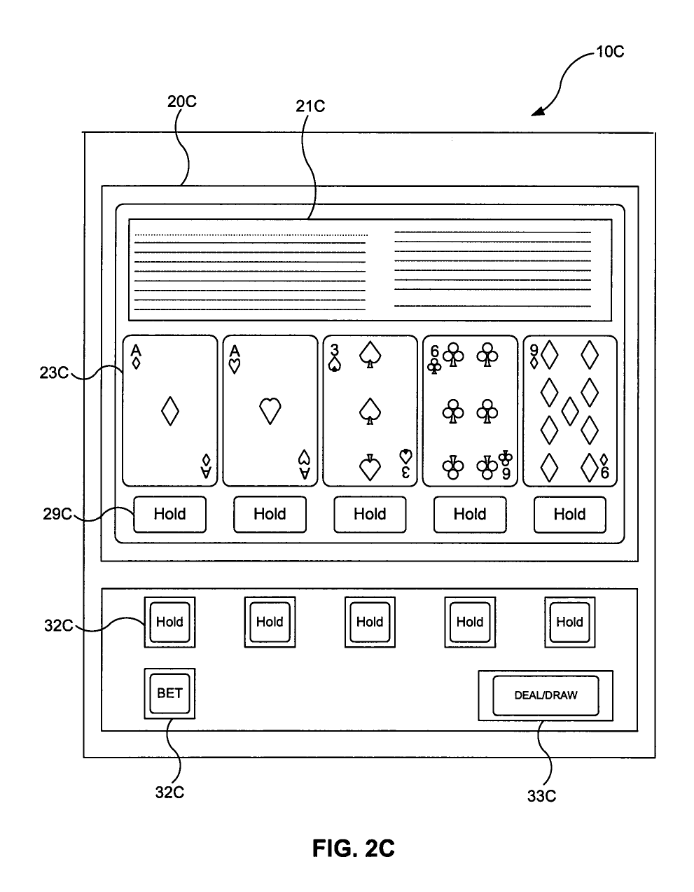

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show any combination of primary game information and ancillary information to the player. For example, the secondary display 25 may show player tracking information, secondary bonus information, advertisements, or player selectable game options.

The gaming device 10 may include a separate information window (not shown) dedicated to supplying any combination of information related to primary game play, secondary bonus information, player tracking information, secondary bonus information, advertisements or player selectable game options. This window may be fixed in size and location or may have its size and location vary temporally as communication needs change. One example of such a resizable window is International Game Technology's “service window”. Another example is Las Vegas Gaming Incorporated's retrofit technology which allows information to be placed over areas of the game or the secondary display screen at various times and in various situations.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicating with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

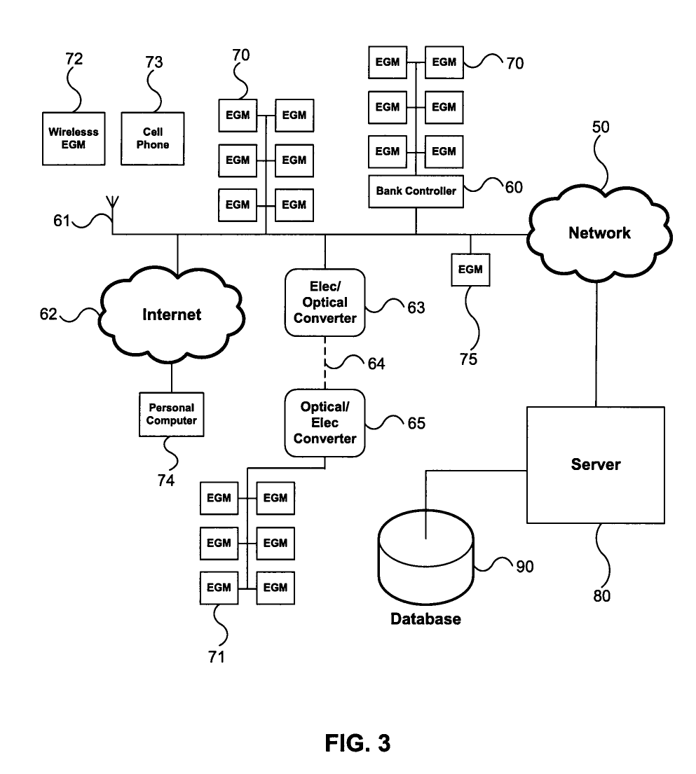

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit, debit or casino account card into a card reader/authorizer (not shown). One of skill in the art will readily see that this invention is useful with all gambling devices, regardless of the manner in which wager value-input is accomplished.

The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIGS. 2A to 2C illustrate exemplary types of gaming devices according to embodiments of the invention. FIG. 2A illustrates an example spinning-reel gaming machine 10A, FIG. 2B illustrates an example video slot machine 10B, and FIG. 2C illustrates an example video poker machine 10C.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23A appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines and various other types of gaming devices known in the art are contemplated and are within the scope of the invention.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, RS-232 lines, firewire lines, USB lines, or other communication protocols. Although not shown in FIG. 3, substantially the entire network 50 may be made of fiber optic lines or may be a wireless network utilizing a wireless protocol such as IEEE 802.11 a, b, g, or n, Zigbee, RF protocols, optical transmission, near-field transmission, or the like.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records in the player database 90 to provide the player with information regarding their player account or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

Using the above described gaming devices in a casino environment can be a pleasurable and entertaining experience for most players. On occasion, however, some players find themselves subjectively unable to stop playing when objective analysis would indicate that the player should stop. For example, a player may play for several hours on a fixed amount of money, and over time, the player's amount of money in play may fluctuate up and down responsive to the outcomes of successive gaming sessions. At some point, the player may hit upon a ‘streak of bad luck’ in which the player receives several lose results in a row and ends up with no money left in play. From an objective standpoint, the appropriate response may be for the player to stop playing, having lost all of the money that they had available for this particular casino visit. However, the player may find himself psychologically unable to stop because he is convinced that a big payout is bound to occur soon. Consequently, the player may seek out more money (from an ATM, cashing a check, or borrowing from friends for example) to continue playing when the player really cannot afford to lose the extra money.

The loss of money that a player cannot afford to lose can have a detrimental effect on the player, the player's family and friends, and society in general, even if it only occurs once. However, when the player repeats the pattern on a recurring basis, becoming addicted to gambling, the effects can be devastating.

According to some embodiments of the invention, the gaming devices and systems described above, as well as the operation of the gaming devices and systems, can be modified to minimize these deleterious effects of casino gaming. The triggers for activation of the modifications can be grouped into two categories: casino established parameters; and player established parameters. The modifications themselves can be loosely grouped into three types: player messaging; gaming device functionality; and physical intervention.

Casino established parameters generally look at a specific player's activities over time to identify problem indicators. For example, a casino established parameter could include the amount of money wagered by the specific player in a certain time period. The time period could be any increment including a month, a week, a day, or an hour. The casino established parameter could apply to a specific player or all players and the limit could be player-specific or generic to all players. Other examples of casino established parameters include: an amount of money lost in a certain time period; an amount of money charged to a credit card in a certain time period; a number of consecutive days of gaming by a specific player; and a total number of days gaming in a given time period.

When a player tracking system is being used, monitoring the status of casino established parameters can be relatively easy because all of the necessary information can be saved in the player account. Then, the information can be processed either on an ongoing basis or at predetermined times to see if any limits have been met. However, it is also possible to monitor player behavior for players that are not using player tracking. For example, play statistics for non-identified players can be tracked either at individual gaming devices or at a gaming server. The statistics can be analyzed on a continuing basis or at predetermined times to identify players on specific machines that have exceeded the limits. Using this method, it is possible to monitor: the amount wagered on a given machine; the losses on a given machine; the duration of play on a given machine; and the play intensity on a given machine.

A person of ordinary skill in the art will recognize that it is easiest to monitor non-identified players on individual gaming devices. However, it is also possible to monitor non-identified players as they play on multiple gaming devices over time by using identification techniques such as movement tracking and feature recognition.

Casino established parameters can be set by casino management and can be varied over time. Further, the casino established parameters can be managed by policies that vary the limits based on the time of day, day of the week, type of gaming device, and the like. The casino established parameters can be enforced by a gaming server such that changes to the limits can be easily entered at the gaming server. Alternatively, the casino established parameters can be enforced at individual gaming devices. In this case, the casino established parameters can either be downloaded to the individual gaming devices from the gaming server or uploaded to each machine individually by a local update system such as a laptop computer.

The casino established parameters may be set for a particular player, for groups of players, or for all players when a player opens a player-tracking account and is issued his or her player-tracking card. This may be accomplished using the same input device, typically a work station, that is used to establish a player account. The casino may, of course, access the player's record anytime after the account is established to change data therein, including any casino established parameters related to gaming limits.

The player established parameters can include the same limits as the casino established parameters described above, such as: an amount of money wagered in a certain time period; an amount of money lost in a certain time period; an amount of money charged to a credit card in a certain time period; a number of consecutive days of gaming; and a total number of days gaming in a given time period. In addition, player established parameters can include: no-gaming days that prevent gaming on specified days; and no-gaming times that prevent gaming at specified times of day. Player established parameters can be set by the player at the time of establishing their player account, upon entering the casino, or just prior to initiating a gaming session, among other times.

The player established parameters can be stored in the player's account so that whenever the player identifies himself on a gaming device (by inserting his player card for example), the player established parameters will be enforced. The player established parameters can be enforced locally by the gaming device (by downloading the player established parameters from a gaming server for example) or they can be enforced remotely by the gaming server.

Although it may seem counterintuitive, the player and casino established parameters can also include a limit tied to an amount won in a certain time period. Oftentimes, players who have had a significant payout will put all of their winnings back into the machine (and more) because psychologically they will feel that they are not losing any money. In such situations, after the player finishes playing, he will then realize that not only has he lost money, but if he had walked away earlier, he would have walked away with significant winnings. This can result in an overall negative impression of the player's gaming experience and a desire not to partake in gaming in the future. Thus, this result is negative both for the player and the casino. To minimize the possibility of such a result, player and/or casino established parameters can be used to stop or discourage play after a jackpot or when the player has been on a ‘winning streak’. When the player is forced to stop play having won some amount of money over and above what the player began with, the player may have an overall positive impression of their gaming experience, which is beneficial to both the player and the casino.

This concept of a limit on wins can also be modified to stop a player from playing when they have lost a certain amount of their winnings (95% for example) so that the player still leaves with a net positive result.

The player may establish his or her limits in a variety of ways. For example, the player could provide these limits to casino personnel when the player-tracking account is first opened. The casino employee opening the account may enter those player-established limits into the player-tracking account, thus associating the player's limits with his or her player-tracking account. Alternatively, a player-accessible work station (not shown) connected to network 50 on the casino floor could be used by each player to access their corresponding account to update information, including adding or changing player-established gaming limits. Finally, a menu screen or other controls may be provided at a gaming device to permit a player to enter or update limits at the gaming device. This interface could be provided via touch screen controls either on display 25 or display 25a. Alternatively, or in addition, game buttons 32 may be used to control data entry into the player's account via the gaming device.

As described above, various limits can be imposed on game play using player established parameters and casino established parameters. Below, the effects of reaching such limits will be described. The effects described below can be triggered by any of the above limits and any combinations of the above-described limits.

When limits are reached, or are close to being reached, messaging can be used to influence play. Messaging can be used to display messages on a specific gaming device being used by a player or can be used to notify a player's designated “friend”, such as through the friend's gaming device, phone, etc., whether or not the friend is physically present with the player at the casino. Also, messaging can be used to provide an audible message on the gaming device, a text message on the player's phone, and/or a recorded message on the player's phone. Messaging can be used to convey a specific message to the player and/or as a distraction to the player, giving the player a chance to stop and evaluate his situation. The player may be required to press a button on the gaming device (or touch the display 20) to acknowledge the message before game play can resume.

Messaging can include: a notification of an approaching limit (either a casino limit or a player limit); a notification of reaching a limit; a notification that continued play is unlikely to result in a win; and notification that play intensity has increased. These messages can be used alone or in conjunction with each other. Further, the messages can be passive, in the sense that they merely provide the player with information to encourage the player to stop, or active, in the sense that they indicate active steps are being taken to stop the player from continuing play. For example, a notification that continued play is unlikely to result in a win can be a simple notification to discourage the player from continuing play or it can be an indication that bonuses have been removed from the gaming device or have decreased value. Other types of game functions that can be tied to messaging are discussed below.

Altering the functionality of the gaming device is another way to encourage or enforce responsible gaming habits. Examples of gaming functionality changes include: preventing the player from increasing the wager amount; reducing the speed at which the player can play; changes to the gaming environment; and adjusting the timing and/or amount of bonuses. The types or triggers of gaming device functionality changes can be set by the casino and/or by the player. For example, gaming device functionality changes can be set in the player account to be applied any time the player is playing. Also, the gaming device functionality changes can be enforced locally at the gaming device (by being downloaded from a gaming server for example) or they can be enforced remotely (by the gaming server for example).

The changes to the gaming environment, which can be gradual or sudden, can take several forms including: decreasing the intensity of the colors and/or sounds of the gaming environment; decreasing the speed of the gaming device; decreasing the allowed wager amount; and reducing the payback percentage. With respect to colors in the gaming environment, the colors may start out as vibrant colors flashing on and off and slowly transition to muted or gray colors with little or no flashing. Similarly, the sounds may start out as very loud and upbeat and then transition to lower volumes and more solemn themes as limits are approached or reached. With respect to speed of the gaming device, the speed of game events (such as cards dealing or reels spinning) can start out at the usual speed and then transition to slower speeds as limits are approached or reached. These slower speeds can have the dual effect of reducing the amount the player is wagering over time and discouraging the player from continuing to play because of the long waits.

With respect to payback percentage, some minimum payback percentage may be mandated by law, for example, 85%. This means that, on average, 85% of the money wagered by players must be returned to players in the form of win results. However, casinos may choose to have higher payouts to encourage player loyalty, increase business, and the like. Consequently, in addition to the 85%, the casino may have an additional payout of up to about 5% for player skill and an additional payout of up to about 5% for identified players. The 5% for identified players can be proportioned so that higher payouts go to loyal players, repeat customers, big spenders, first-timers, and the like. These extra payout percentages can be decreased in response to players approaching or reaching limits. The extra payout percentages can come from a pool and be distributed according to the size of the pool. In the case where the payout percentages are decreased for a particular player, the increased revenue can be placed back in the pool, to benefit all of the other players, it can be kept by the casino (or distributed to a charity, such as gambling addiction programs), or it can be applied to the player account to increase the payout percentages for the player's next visit to the casino.

Instead of, or in addition to, reduction of payback percentage as just described, a player's accrued loyalty points may be reduced. The reduction may be elimination of points accrued for the current visit only or also for prior visits. Alternatively, for the remainder of the current session or additional future sessions, point accrual may be eliminated or reduced. These can be phased in if play continues, e.g., starting with reduction of points only on current visit, then elimination of those points and continuing with reduction/elimination of additional accrued or future points until play stops.

The timing and/or amount of bonuses can also be adjusted. For example, the casino may set a baseline bonus amount and default timing for achieving a particular bonus. Then, the player or the casino may set up the bonus to decrease in amount or increase in time responsive to certain player behaviors (such as amount lost per increment of time). Thus, the player may know in advance that bonuses are going to be less frequent (or of diminished amount) if the player meets a limit or the player may be notified about the decreasing bonus (by a message on the gaming device for example).

Any of the functionality adjustments discussed above can be set up with both an activate and a reset limit. In other words, an activate limit (such as amount lost in a given time period) can be set and then a reset limit can also be set. The reset limit can be a specific time period or other value. For example, if the activate limit is a specified intensity of game play, the reset limit can be some lower intensity of game play. Further, if the limit is an amount lost in an hour, the reset limit could be an hour of idle time. Giving the player a specified amount of idle time could allow the player to sober up, re-evaluate his situation, or just get bored and decide to stop playing. For players who are having trouble managing their play behavior, any of these could be desirable outcomes.

A third approach to player behavior modification is intervention. The interventions can range from mild (such as denying alcoholic drinks to the player) to severe (such as locking out the player or removing him or her from the casino). However, it should be kept in mind that these interventions may actually be chosen by the player to help them address known problems with their gaming behavior. According to some embodiments, an indicator on a gaming device (such as the candle light indicator 19) can be used to signal that no more alcoholic drinks are to be served to the player at the gaming device. Further, a signal can be sent to the drink dispensing station in the casino to notify the bartender and/or wait staff not to serve any more drinks to a particular player.

With regard to locking out the player, the player can be locked out on an individual gaming device or the player can be locked out of all gaming devices in the casino. The locked-out condition can last for a pre-determined time. As examples, the player can be locked out for an hour, a day, or a month, or portions of each. Further, the locked-out condition can remain in force until the player completes some task. For example, a player may know that they are prone to play irresponsibly after consuming alcohol. Accordingly, the player may set up their player account such that if a certain limit (for example, amount lost in an hour) is reached, the player may be locked out until the player goes to a customer service desk and obtains a favorable blood-alcohol-content reading (by a breathalyzer test for example), consumes a meal, or takes a break.

As another type of intervention, a notification could be sent to a third party. The third party can be a friend or family member of the player and can be identified in the player account. The notification can be a simple message to the third party that the player has reached a limit and/or it can be a notification that includes the location of the player. Following such a notification, a timer could be set to prevent further interventions for a predetermined time to allow the third party time to take action. The notification can take the form of a phone call, a text message, and/or an email, or any other form of communication.

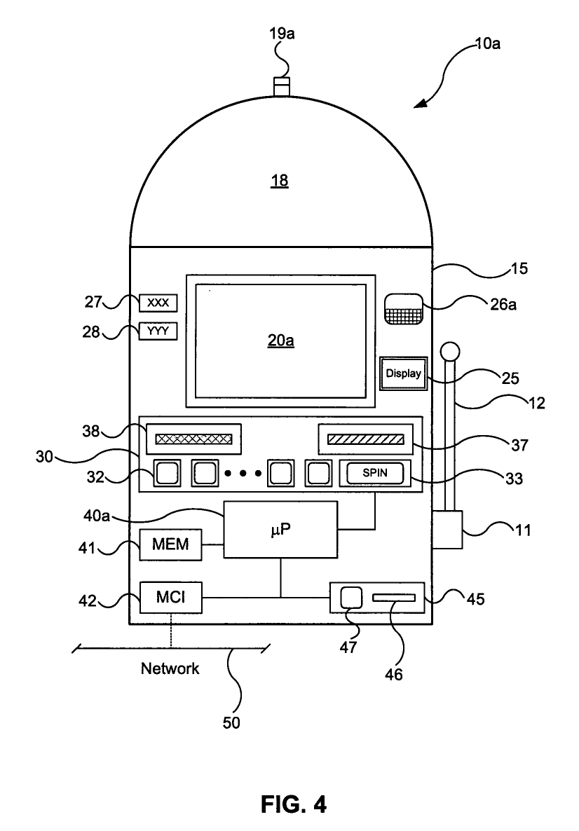

FIG. 4 is a functional block diagram that illustrates a gaming device according to some embodiments of the invention.

Referring to FIG. 4, a gaming device 10a can include a microprocessor 40a. The microprocessor 40a can be configured to enforce behavioral gaming limits. The microprocessor 40a can also be configured to receive behavioral gaming messages from a gaming server through the MCI 42. The display 20a of the gaming device 10a can be configured to display behavioral gaming messages supplied by either the microprocessor 40a or the gaming server. The speaker 25a and the indicator 19a can also be configured to support behavioral gaming. For example, the speaker 26a can announce messages to the player encouraging the player to stop play. Also, the indicator 19a can be configured with a special section or to flash in a specific way so as to indicate that the associated player is not to be served any more alcoholic beverages.

The microprocessor 40a can also be configured to track statistical data for gaming sessions and store such data in the memory 41. As used here, the term statistical data refers to data collected other than simply the number of gaming sessions initiated by the player. The statistical data can be used locally to determine when a player has reached a limit or the data can be uploaded to the gaming server. Further, when a player identifies himself to the gaming device 10a (using the card reader 46 for example), the gaming device 10a can download behavioral gaming data from the gaming server along with the associated player account information. When the player ends a gaming session or stops play on the gaming device 10a, the gaming device 10a can also upload the statistical data relating to the player's gaming sessions to the gaming server.

Alternatively, or in addition, statistical data can be continuously uploaded to the gaming server, especially when the network is operating in a server-based gaming setup.

The gaming device 10a can be configured to enforce behavioral gaming limits by recognizing that a limit has been reached or is about to be reached and then taking the appropriate actions in response to such recognition. For example, the gaming device 10a can recognize that a limit is approaching or has been reached by downloading the limit or limits from a gaming server and then comparing the limit(s) to statistical data collected during play. Alternatively, the gaming server can be responsible for comparing the limits with the player's statistical data. In this case, the gaming device 10a can recognize that a limit is approaching or has been reached by being notified of such from the gaming server. Accordingly, the gaming device 10a can recognize that a limit is approaching or has been reached by: accessing casino/player established parameters stored in the memory 41; and/or accessing casino/player established parameters from the gaming server. The parameters stored in the memory 41 or the gaming server can be player specific or generic to all players.

As can be seen from the above description, several components must cooperate with one another for a player's behavior to be effectively monitored and the appropriate limits enforced. There is first, the casino and/or player established limits. Second, there is the accrued behavioral gaming data, such as how much has been wagered, won and/or lost over at least one time period. Finally, the present embodiment includes a computer-implemented process that periodically updates behavioral gaming data, compares the updated data to predefined limits, and makes decisions about whether to enforce the limits. It should be appreciated that these components can cooperate at the player's gaming device, on a network server, or distributed on the network. In addition, the process may run periodically, wherever it is located, or it may run substantially continuously to produce substantially real-time results. Those skilled in the art will readily appreciate numerous possible implementations of these components to achieve the results described herein.

Once the gaming device 10a has recognized that a limit is approaching or has been reached, the gaming device 10a takes the appropriate actions. This can include any of the enforcement options discussed above including: locking out the player; displaying a message on the display 20a; making an audible announcement through the speaker 26a; etc. The gaming device 10a can decide on the appropriate actions to take by: accessing information stored in the memory 41 (downloaded from the gaming server along with player account information for example); accessing information from the gaming server; or being directed to perform specific actions from the gaming server. The appropriate actions can include any of the actions described above, such as messaging, game functionality changes, and/or intervention.

It should be noted that the player and the casino may each establish limits for the same parameter, e.g., consecutive losing plays. In such a situation, a limit selected one by may be reached before a limit selected by the other. Rules may be provided to control which limit is enforced. For example, the casino selects a maximum loss of $300 in any 24-hour period, and the player has selected a maximum loss of $500 per month. In a session during the last day or two of a month, the player loses $200 and reaches the total loss allowed in a month. The game implements the selected modification, e.g., locking out, even though the limit set by the casino has not been reached.

In another example, the casino sets a loss limit of $500 per player for a defined time period-unless the player sets a higher limit, which may or may not require casino approval. In this situation, even if the casino limit is reached, a rule may be implemented that permits further play because the player limit has not been reached. This rule may be implemented for all players or only for those who meet certain qualifications.

It should be appreciated that substantially all of the foregoing embodiments could be implemented equally well in an Internet-gaming context, e.g., on personal computer 74 in FIG. 3. In other words, similar limits could be selected by the player and/or the Internet-gaming provider. And similar modifications, including messaging, device functionality, and intervention could be made.

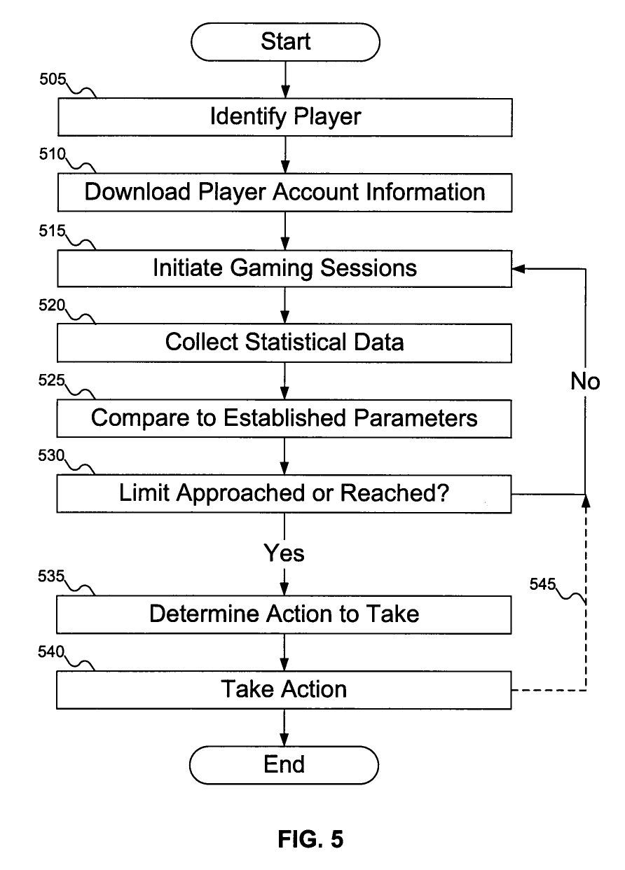

FIG. 5 illustrates a method of operating a gaming device according to some embodiments of the invention.

Referring to FIG. 5, a player identifies himself to a gaming device in step 505. The gaming device can include one or more casino established parameters for behavioral gaming (also referred to as behavioral gaming limits). At step 510, player account information is downloaded to the gaming device from a gaming server. The player account information includes player established parameters for behavioral gaming (player established parameters can also be referred to as behavioral gaming limits). At step 515, the player initiates one or more gaming sessions on the gaming device. Statistical data from the one or more gaming sessions is collected by the gaming device at step 520. At step 525, the statistical data is compared to the casino established parameters and the player established parameters. The statistical data can be compared to the parameters after each gaming session, after a preset number of gaming sessions, or periodically at regular time intervals. At step 530, a decision is made as to whether the player has reached, or is about to reach, any of the behavioral gaming limits. If a limit has not been reached or is not about to be reached, the method returns to step 515. If a limit has been reached or is about to be reached, a determination is made as to what action should be taken at step 535. This determination can include accessing memory in the gaming device or it can include requesting the appropriate action from the gaming server. Determining the appropriate action can include accessing a corresponding action to the particular limit that has been reached or it can include accessing an action that does not correspond to the particular limit. For example, the casino/player established parameters can specify that the first time any limit is reached, the appropriate action is displaying a message on the gaming device, the second time any limit is reached, the appropriate action is decreased game speed, and so on. At step 540, the appropriate action is taken. The appropriate action can include any of the actions described above, including messaging, gaming device functionality changes, and intervention. As shown by alternate path 545, after the appropriate action is taken, the method may return to step 515. As an example, if the appropriate action is displaying a message, the player can be allowed to continue play once the message is displayed.

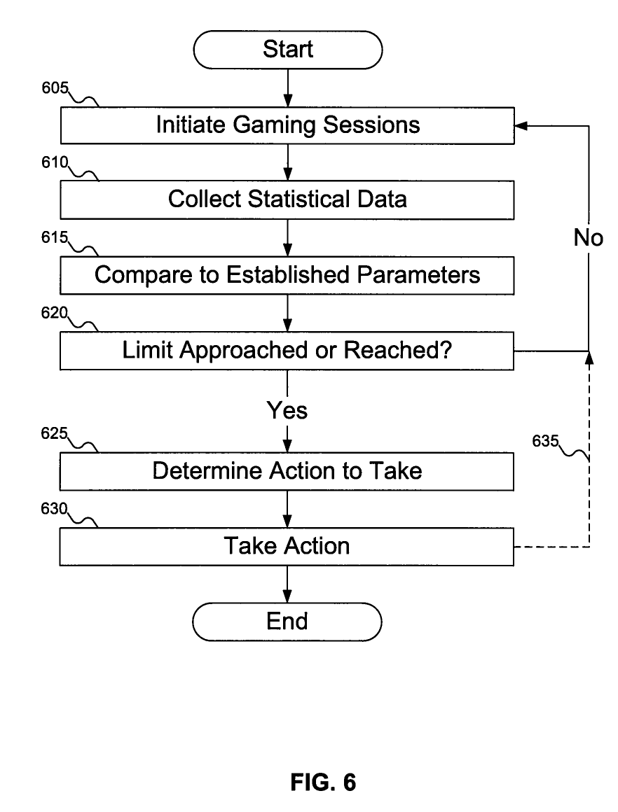

FIG. 6 illustrates another method of operating a gaming device according to some embodiments of the invention.

Referring to FIG. 6, a player initiates one or more gaming session on a gaming device at step 605. The gaming device includes casino established parameters for behavioral gaming. In this method, the player is not identified by the gaming device. Statistical data from the one or more gaming sessions is collected at step 610. At step 615, the statistical data is compared to the casino established parameters. The statistical data can be compared to the parameters after each gaming session, after a preset number of gaming sessions, or periodically at regular time intervals. At step 620, a decision is made as to whether the player has reached, or is about to reach, any of the limits specified in the casino established parameters. If a limit has not been reached or is not about to be reached, the method returns to step 605. If a limit has been reached or is about to be reached, a determination is made as to what action should be taken at step 625. This determination can include accessing memory in the gaming device or it can include requesting the appropriate action from the gaming server. Determining the appropriate action can include accessing a corresponding action to the particular limit that has been reached or it can include accessing an action that does not correspond to the particular limit. At step 630, the appropriate action is taken. The appropriate action can include any of the actions described above, including messaging, gaming device functionality changes, and intervention. As shown by alternate path 635, after the appropriate action is taken, the method may return to step 605.

As described above, gaming devices can be configured and/or operated to reduce the adverse effects of undesirable gaming behavior. This method of altering behavior directly at the gaming site may be more effective than traditional approaches focused on the player's individual ability to control their own behavior.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A method of conducting a game of chance, comprising:
establishing behavioral gaming criteria at a gaming server;
collecting statistical data associated with a player from a plurality of gaming sessions;
comparing the statistical data to the behavioral gaming criteria; and
initiating an action responsive to the comparing to alter behavior of the player.

2. The method of claim 1, wherein the behavioral gaming criteria include one or more parameters established by the casino.

3. The method of claim 2, further comprising:
retrieving the parameters from the gaming server; and
storing the parameters at a gaming device.

4. The method of claim 2, further comprising uploading the statistical data associated with the player to the gaming server and wherein comparing the statistical data to the behavioral gaming criteria comprises comparing the statistical data to the parameters at the gaming server.

5. The method of claim 1, further comprising:
identifying the player; and
obtaining the behavioral gaming criteria responsive to the identifying.

6. The method of claim 5, wherein obtaining the behavioral gaming criteria includes downloading player established parameters from the gaming server.

7. The method of claim 1, wherein initiating the action comprises displaying a message on a gaming device associated with the player.

8. The method of claim 7, further comprising requiring the player to acknowledge the message before game play can resume.

9. The method of claim 7, wherein displaying the message includes displaying a message indicating that the player is approaching a preset limit.

10. The method of claim 7, wherein displaying the message includes displaying a message indicating that the player has reached a preset limit.

11. The method of claim 7, wherein displaying the message includes displaying a message notifying the player that subsequent wins are unlikely.

12. The method of claim 7, wherein displaying the message includes displaying a message notifying the player that play intensity has increased.

13. The method of claim 1, wherein initiating the action comprises modifying a function of a gaming device associated with the player.

14. The method of claim 13, wherein modifying the function comprises at least one of locking out the player, preventing higher wagers by the player, adjusting the amount of a bonus, changing a payback percentage, and adjusting a bonus timing.

15. The method of claim 13, wherein modifying the function comprises changing a gaming environment on a gaming device associated with the player.

16. The method of claim 15, wherein changing the gaming environment comprises at least one of altering the colors of the gaming environment, altering the sounds of the gaming environment, and decreasing the speed of the gaming device.

17. The method of claim 1, wherein the behavioral gaming criteria include at least one of an amount wagered in a certain time period, an amount of credits lost in a specified time period, an amount of money withdrawn from a charge account in a time period, a number of consecutive days gaming, and a number of days gaming in a given time period.

18. The method of claim 1, wherein initiating the action comprises at least one of denying alcoholic beverages to the player, barring the player from continuing game play, and notifying a third party.

19. The method of claim 18, wherein notifying the third party comprises notifying a third party identified in advance by the player.

20. A method of conducting a game of chance, comprising:
identifying a player;
obtaining player established parameters associated with the player; and
preventing the player from participating in the game of chance responsive to the player established parameters.

21. The method of claim 20, wherein the player established parameters include at least one of no-gaming days that restrict gaming on specified days and no-gaming times that restrict gaming at specified times of day.

22. A gaming device, comprising:
a player interface panel including a plurality of buttons;
a display configured to display information to a player; and
a processor configured to collect statistical data associated with a player and provide triggered actions responsive to behavioral gaming limits established at a gaming server.

23. The gaming device of claim 22, wherein the triggered actions include displaying a message on the display to modify player behavior.

24. The gaming device of claim 23, wherein the message includes at least one of an indication that the player is approaching a preset limit, an indication that the player has reached the preset limit, a notification that subsequent wins are unlikely, and a notification that play intensity has increased.

25. The gaming device of claim 22, wherein the triggered actions include changing a function of the gaming device responsive to the behavioral gaming limits.

26. The gaming device of claim 25, wherein the function comprises at least one of a player lockout, a maximum wager, an amount of a bonus, a payback percentage, and a bonus timing.

27. The gaming device of claim 25, wherein the function comprises a gaming environment on the gaming device.

28. The gaming device of claim 27, wherein the gaming environment comprises at least one of colors, sounds, and speed of the gaming device.

29. The gaming device of claim 22, wherein the triggered actions include alerting casino personnel responsive to the behavioral gaming limits.

30. The gaming device of claim 22, wherein the triggered actions include alerting a third party responsive to the behavioral gaming limits.

31. The gaming device of claim 22, further comprising a memory to store at least one of casino established parameters and player established parameters.

32. The gaming device of claim 22, further comprising a network interface configured to exchange communications with a gaming server, the communications including at least one of casino established parameters, player established parameters, and the triggered actions.

33. A gaming system, comprising:
at least one gaming device;
a gaming server; and
a network connecting the gaming server to the gaming device,
wherein the gaming device and the gaming server are configured to enforce behavioral gaming limits.

34. The system of claim 33, further comprising a gaming database connected to the network and configured to store the behavioral gaming limits, wherein the behavioral gaming limits comprise at least one of casino established parameters and player established parameters.

35. The system of claim 33, wherein the gaming device is configured to:
receive an identifier for a player; and
retrieve player established parameters from the gaming server responsive to the identifier.

36. The system of claim 33, wherein the gaming device is configured to collect statistical data associated with a player from gaming sessions on the gaming device.

37. The system of claim 36, wherein the gaming device is configured to compare the statistical data with the behavioral gaming limits and initiate a triggered action responsive to the comparing.

38. The system of claim 37, wherein the triggered action comprises displaying a message on the gaming device.

39. The system of claim 38, wherein the message includes at least one of an indication that the player is approaching a preset limit, an indication that the player has reached the preset limit, a notification that subsequent wins are unlikely, and a notification that play intensity has increased.

40. The system of claim 37, wherein the triggered action comprises modifying a function of the gaming device.

41. The system of claim 40, wherein the function comprises at least one of a player lockout, a maximum wager, an amount of a bonus, a payback percentage, and a bonus timing.

42. The system of claim 40, wherein the function comprises a gaming environment on the gaming device.

43. The system of claim 42, wherein the gaming environment comprises at least one of colors, sounds, and speed of the gaming device.

44. The system of claim 37, wherein at least one of the gaming server and the gaming device is configured to alert casino personnel responsive to the behavioral gaming limits.

45. The system of claim 37, wherein at least one of the gaming server and the gaming device is configured to alert a third party responsive to the behavioral gaming limits.

46. The system of claim 45, wherein the third party is identified in a player account associated with the player.

47. The system of claim 33, wherein the behavioral gaming limits include at least one of an amount wagered in a certain time period, an amount of credits lost in a specified time period, an amount of money withdrawn from a charge account in a time period, a number of consecutive days gaming, and a number of days gaming in a given time period.

48. The system of claim 33, wherein the gaming server is configured to receive statistical data from the gaming device and compare the statistical data to the behavioral gaming limits.

49. The system of claim 48, wherein the gaming server is further configured to initiate a triggered action responsive to the comparing.

50. The system of claim 49, wherein the triggered action comprises at least one of sending a message to the gaming device for display on the gaming device and directing the gaming device to alter the functionality of the gaming device.
